(19) United States
(12) Patent Application Publication
(10) Pub. No.: US 2026/0358177 A1
(43) Pub. Date: Nov. 12, 2026

(54) METHOD AND DEVICE OF QUANTUM HOMODYNE DETECTION USING CAMERA SENSOR

(71) Applicant: Korea Advanced Institute of Science and Technology, Daejeon (KR)

(72) Inventors: Youngsik RA, Daejeon (KR); Youngdo YOON, Daejeon (KR); Chan ROH, Daejeon (KR); Geunhee GWAK, Daejeon (KR)

(73) Assignee: Korea Advanced Institute of Science and Technology, Daejeon (KR)

(21) Appl. No.: 19/672,420

(22) Filed: May 8, 2026

(30) Foreign Application Priority Data
May 9, 2025 (KR) 10-2025-0060116
Sep. 1, 2025 (KR) 10-2025-0123065

(51) Int. Cl. G01J 9/02; G01J 3/18; G01J 3/28; G01J 9/00

(52) U.S. Cl. CPC G01J 9/02; G01J 3/18; G01J 3/2823; G01J 2003/2826; G01J 2009/004

(57) ABSTRACT

The present disclosure relates to a method and device for quantum homodyne detection using a camera sensor, wherein a camera sensor having a plurality of pixels respectively corresponding to different wavelengths detects photons in each of the wavelengths from a quantum state dispersed across the wavelengths through the pixels, and a digital processor may be configured to simultaneously measure quadrature results of wavelength modes defined respectively corresponding to the wavelengths, based on the photons respectively detected in the pixels.

### CROSS-REFERENCE TO RELATED APPLICATIONS

This application claims the benefit of priority under 35 U.S.C. § 119 to Korean Patent Application No. 10-2025-0060116 filed on May 9, 2025, and Korean Patent Application No. 10-2025-0123065 filed on Sep. 1, 2025, in the Korean Ministry of Intellectual Property (MOIP), the entire contents of which are incorporated herein by reference.

### BACKGROUND

### 1. Field

The present disclosure relates to a method and device for quantum homodyne detection using a camera sensor.

### 2. Description of Related Art

Quantum homodyne detection technology plays a role of quantum measuring a quantum state and is widely used in quantum technology. Existing quantum homodyne detection technology used a single photodiode or a photodiode array, but due to the complexity of the detector, there is a limit to the number of optical modes capable of simultaneous detection. Since a camera sensor is composed of many pixels, the number of simultaneously detectable optical modes can be drastically increased, but due to the noise of the camera sensor, quantum homodyne detection reaching a quantum noise limit (quantum-limited noise) is impossible.

Therefore, in order to expand the scale of quantum technology, a technology for increasing the number of optical modes that can be simultaneously detected by a quantum homodyne detection device corresponding to a quantum state measurement unit is needed.

### SUMMARY

The present disclosure provides a method and device for quantum homodyne detection using a camera sensor.

In the present disclosure, a quantum homodyne detection device may include a camera sensor having a plurality of pixels respectively corresponding to different wavelengths, and configured to detect photons in each of the wavelengths from a quantum state dispersed across the wavelengths through the pixels, and a digital processor configured to simultaneously measure quadrature results of wavelength modes defined corresponding to each of the wavelengths, based on the photons respectively detected in the pixels.

In the present disclosure, a quantum homodyne detection device may include an oscillator having a uniform spectrum across a wavelength range including different wavelengths, a laser configured to generate a quantum state with quantum light having a center wavelength of the wavelength range, a beam splitter configured to interfere the quantum state and the spectrum to output two output beams, diffraction gratings and optical systems configured to respectively disperse the output beams across the wavelengths, a camera sensor having a plurality of pixels respectively corresponding to the wavelengths, and configured to receive the output beams to detect photons in each of the wavelengths through the pixels, and a digital processor configured to simultaneously measure quadrature results of wavelength modes defined corresponding to each of the wavelengths, based on the photons detected in the pixels.

In the present disclosure, a quantum homodyne detection method may include a step in which a camera sensor having a plurality of pixels respectively corresponding to different wavelengths detects photons in each of the wavelengths from a quantum state dispersed across the wavelengths through the pixels, and a step in which a digital processor simultaneously measures quadrature results of wavelength modes defined corresponding to each of the wavelengths, based on the photons respectively detected in the pixels.

According to the present disclosure, a quadrature value of a wavelength multimode quantum state can be simultaneously acquired using a camera. The core idea is that the camera operates as a spectrally resolved detector, and each pixel detects light of a different wavelength. This method recorded the largest number of modes at the present time by expanding the number of simultaneous quadrature measurement modes, which was a maximum of 8 modes in existing studies, to 60. As crosstalk between modes is small, electronic noise is low, and a Gaussian distribution of a vacuum state quadrature exists, the present camera detection system operates as an effective multimode homodyne detector. In particular, all of these performances were implemented with only nW-class LO power.

This can be utilized for the development of scalable quantum technology by drastically increasing the scale of a quantum measurement device corresponding to a measurement unit of quantum technology. And, it provides a technology for simultaneously measuring a large-scale quantum state in the quantum computing field. In addition, it can be utilized for quantum imaging and quantum spectroscopy technologies using quantum light in the quantum sensing field. Furthermore, it can be utilized for quantum key distribution and quantum teleportation technologies in the quantum communication field.

### BRIEF DESCRIPTION OF THE DRAWINGS

FIGS. 1A to 1F are drawings for explaining camera-based homodyne detection according to the present disclosure;

FIGS. 2A to 2D are drawings for explaining verification results of an EPR quantum entangled state of 30 pairs measured with the camera-based homodyne detector according to the present disclosure;

FIGS. 3A to 3I are drawings for explaining measurement results of a multipartite entangled state according to the present disclosure;

FIGS. 4A to 4C are drawings for explaining multimode RSP according to the present disclosure; and

FIG. 5 is a drawing illustrating an operating method of the quantum homodyne detection device according to the present disclosure.

### DETAILED DESCRIPTION

Hereinafter, the present disclosure provides a method and a device for quantum homodyne detection using a camera sensor. The camera sensor has been mainly utilized for photon measurement (e.g., Electron Multiplying Charge-Coupled Device), but has not been applied to quantum homodyne technology that measures an electric field quadrature of light. Development of a quantum homodyne detection device capable of utilizing many pixels of a camera sensor is needed. A quantum homodyne detection technology that reaches a quantum noise limit by removing noise of the camera sensor is needed.

Now, various embodiments of the present disclosure will be described with reference to the accompanying drawings.

The present disclosure relates to simultaneous quadrature measurement of 60 modes of quantum light with a camera. Not only the size of a quantum state but also the capacity of a detector determines the performance of quantum technology. However, until now, the scalability of a measurement system has not sufficiently kept up with the development of state generation technology. Existing multimode quantum light field measurement has faced fundamental physical limits such as high optical power and large physical space. In the present disclosure, a camera-based detector capable of performing simultaneous quadrature measurement on 60 modes of quantum light for the first time was implemented. Using the present detector, quadrature values of 30 pairs of EPR states were simultaneously acquired, and it was experimentally demonstrated that squeezing exists for all modes. In addition, multimode entanglement certification and a remote state preparation (RSP) protocol were performed. By overcoming the scalability limit of quadrature measurement, the present detector opened up the possibility of characteristic analysis and utilization of high-dimensional multimode quantum states.

### 2. Introduction

As quantum information science advances toward practical technology, the scalability of a quantum system is becoming increasingly important in determining the performance of quantum computers, networks, sensors, and the like. In this context, continuous-variable (CV) quantum optics, which encodes quantum information in an electric field of light, is attracting attention as a promising platform. A CV system is capable of deterministic entanglement generation, and maintains advantages such as a long coherence length and high bandwidth possessed by an optical system. Therefore, a CV approach is widely used in fields requiring large-scale entangled states, for example, measurement-based quantum computing, Gaussian boson sampling, multimode parameter estimation, and the like.

However, in order to implement true scalable quantum processing, quantum measurement must also be scalable so that information can be extracted from all modes. In CV quantum optics, a multimode homodyne detector that simultaneously measures a quadrature value of each mode performs this role. In existing studies, simultaneous quadrature measurement was attempted using a plurality of single-mode homodyne detectors or a multimode homodyne detector using a photodiode array. However, they faced a scalability problem in that a high-power local oscillator (LO) of mW class and a separate amplification circuit for each measurement mode are required. As the number of modes increases, this problem becomes more serious.

As an alternative strategy for solving this scalability problem, there is a method of replacing an existing homodyne detector with a camera. A camera sensor is composed of thousands of pixels, and each pixel can sense different modes in parallel. For example, in discrete-variable quantum optics, a camera can sense multimode photons having different positions or momentums. Cameras have been utilized for various tasks such as determination of quantum correlation and spatial characteristics of a single photon, quantum imaging, and the like. Similarly, in the field of CV quantum optics, cameras have been used to measure the variance of a quantum state through shadow imaging or classical homodyne imaging. Recently, a study observing squeezing in a multimode squeezed vacuum state by combining a camera and a phase-sensitive amplifier has also been reported. However, none of the studies up to now have directly accessed a quadrature value of a multimode quantum state or successfully identified its entanglement characteristics.

In the present disclosure, a method of simultaneously acquiring a quadrature value of a wavelength multimode quantum state using a camera was demonstrated for the first time. A core idea is that the camera operates as a spectrally resolving detector, and each pixel senses light of a different wavelength. By expanding the number of simultaneous quadrature measurement modes, which was a maximum of 8 modes in existing studies, to 60, this method recorded the largest number of modes at the present time. As crosstalk between modes is small, electronic noise is low, and a Gaussian distribution of a vacuum state quadrature exists, the present camera detection system operates as an effective multimode homodyne detector. In particular, all these performances were implemented with only nW-class LO power.

Using the present detector, 30 pairs of Einstein-Podolsky-Rosen (EPR) entangled states generated in 60 wavelength modes were simultaneously measured. Squeezing was observed in all EPR modes, and an entanglement criterion was satisfied. Subsequently, a quadrature value of the multimode entangled state was measured, and the entanglement criterion was certified using an individual quadrature dataset. Finally, multimode remote state preparation (RSP) between two parties was performed using these EPR pairs, and it was confirmed that a change in variance occurred as a measurement phase for each mode of a sender was adjusted. Squeezing and anti-squeezing variances observed after RSP coincided with the variance of a conditionally measured Gaussian state.

### 3. Multimode Homodyne Detection

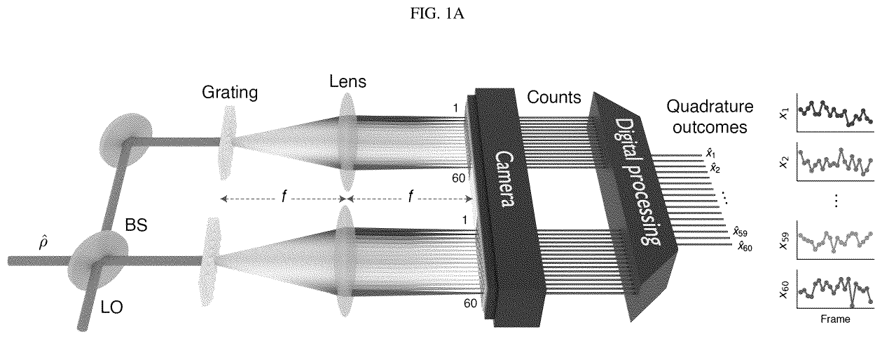

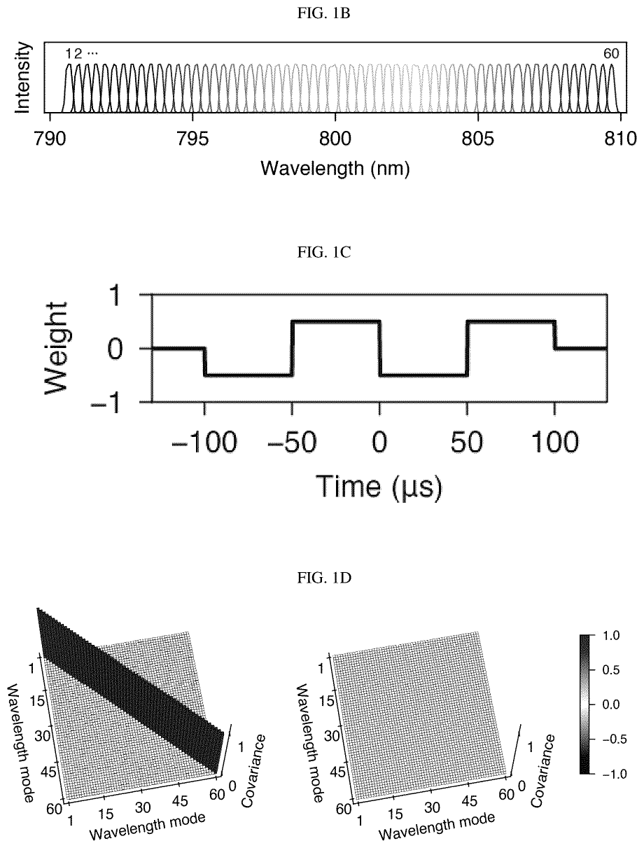

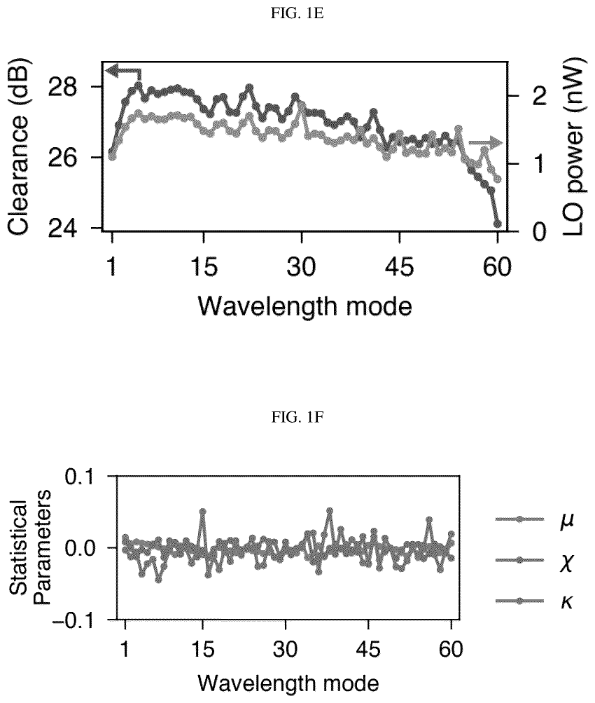

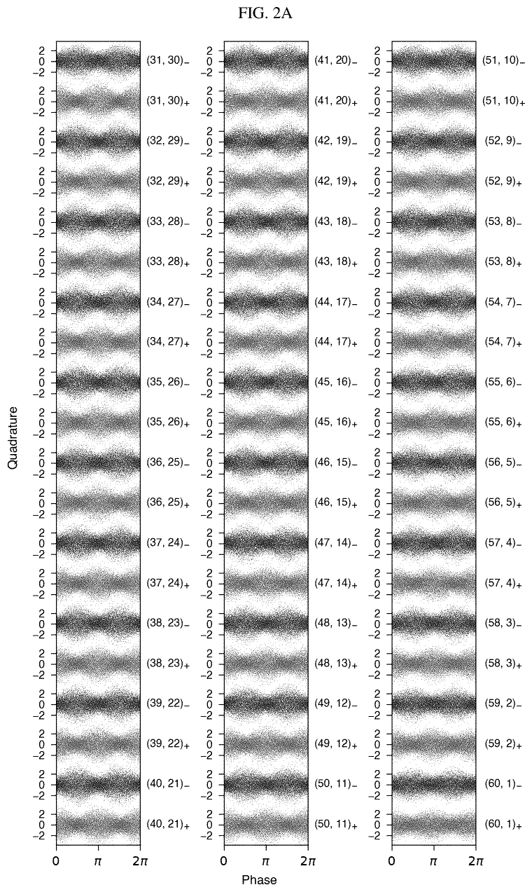

FIGS. 1A to 1F are drawings for explaining camera-based homodyne detection according to the present disclosure.

FIG. 1A illustrates a quantum homodyne detection device. A 75 fs pulse generated from a titanium (Ti): sapphire laser having a center wavelength of 800 nm and a repetition rate of 80 MHz was used. For multi-wavelength homodyne detection, a local oscillator (LO) having a uniform spectrum over a range of 790 nm to 810 nm was prepared. After being attenuated, this LO interfered with a wavelength multimode quantum state (p) at a 50:50 beam splitter (BS). Two output beams of the beam splitter (BS) passed through a diffraction grating and a 2f optical system, for example, a lens, and then were separated by wavelength, that is, dispersed according to 60 different wavelengths. A camera sensor of a camera (e.g., Teledyne Blaze 400 HR) sensed light of different wavelengths at different pixels, that is, recorded a photon count at each wavelength. A digital processor converted a raw camera count value into a quadrature result through the following three steps. (1) A wavelength mode was defined by corresponding a camera pixel to a specific wavelength. This is shown in FIG. 1B. (2) Classical noise was removed by weighted-summing counts obtained at four adjacent time points using a data acquisition weight shown in FIG. 1C. (3) Balanced homodyne detection was performed by subtracting signals obtained from two homodyne output ports. Through this method, quadrature values for 60 different wavelength modes having an overlap probability between modes of less than 4.5% were simultaneously acquired. Therefore, each wavelength mode can be considered to be independent.

In order to evaluate the performance of the multimode homodyne detector, crosstalk between different modes was first checked. In an ideal case, all quadrature variances of shot noise are normalized to 1, crosstalk between different modes does not exist, and electronic noise (camera count when there is no LO) should be negligibly small compared to the shot noise. In this case, a covariance matrix of the shot noise should be an identity matrix, and a covariance matrix of electronic noise should be a zero matrix. FIG. 1D shows covariance matrices for shot noise (left) and electronic noise (right), respectively. Off-diagonal elements of the experimentally obtained shot noise covariance matrix showed a deviation of up to 2.2% from the ideal case, and the maximum variance of the electronic noise was at a level of 0.35% with respect to the shot noise variance. This result means that crosstalk caused by the camera is at a negligible level, and common mode noise from the two detector ports was effectively removed.

Next, statistical characteristics of the shot noise were analyzed. FIG. 1E shows clearance and LO power for each wavelength mode. Clearance represents a signal-to-noise ratio, and is defined as 10 log (Vs/Ve) using a quadrature variance (Vs) of shot noise and a variance (Ve) of electronic noise. In all wavelength modes, the clearance exceeded 20 dB, which was achieved with only nW-level LO power. On the other hand, an existing homodyne detector requires mW-level LO power per mode. Due to this, the present detector system shows that scalability was greatly improved by drastically lowering the required LO power. In addition, an offset, skewness, and excess kurtosis of a shot noise quadrature distribution were evaluated, and are shown in FIG. 1F. All these values are close to 0, which means that a measurement result of the shot noise follows a Gaussian distribution corresponding to a vacuum state without a mean field.

### 3. EPR State

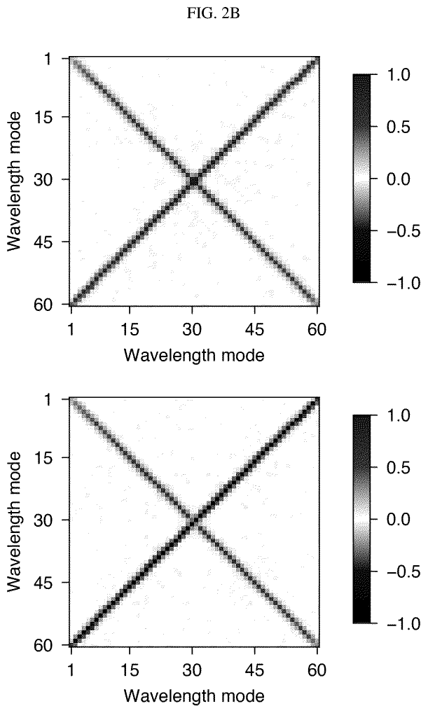

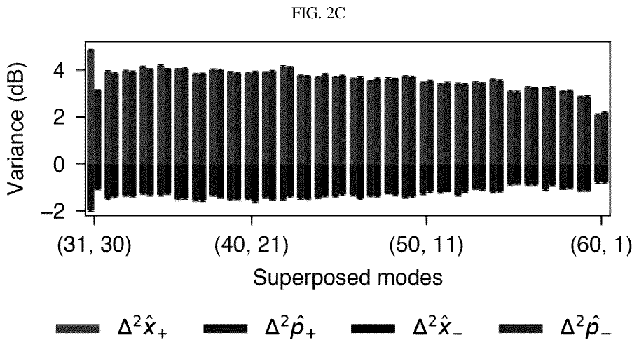

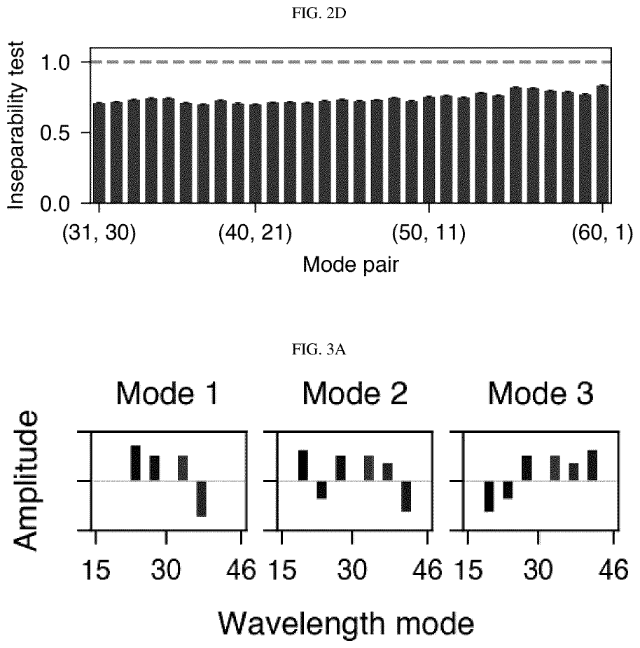

FIGS. 2A to 2D are drawings for explaining verification results of an EPR quantum entangled state of 30 pairs measured with the camera-based homodyne detector according to the present disclosure.

Next, the present disclosure explored the ability to measure a high-dimensional multimode quantum light state using the camera-based homodyne detector. A synchronously pumped optical parametric oscillator (SPOPO) was used to measure 60 wavelength band quadratures of a generated multimode quantum state. The overall experimental setup is summarized in FIG. 2A. Using the multimode homodyne detector, quadrature values of 30 pairs of EPR states generated on wavelength modes by the SPOPO were acquired while scanning the phase of the LO. In each measurement run, 60 quadrature values were simultaneously obtained, and at this time, a quadrature angle is changed, and in this case, only random noise is observed because each mode is in a thermal state.

On the other hand, if a sum or difference of quadrature values of a correct pair is investigated due to correlation, a qualitatively new characteristic is observed. FIG. 2A shows a total of 24,000 quadrature values simultaneously acquired for 30 pairs of EPR symmetric modes (red, +) and antisymmetric modes (blue, −) as the LO phase changes. At this time, the symmetric and antisymmetric modes are respectively defined as in [Equation 1] below.

$$\begin{matrix}{( 30 + n , 31 - n )}_{\pm } ≡ \frac{1}{\sqrt{2}} ( {\hat{a}}_{30 + n} \pm {\hat{a}}_{31 - n} ) \\ Here , 1 \leq n \leq 30 , {\hat{x}}_{j} = {\hat{a}}_{j} + {\hat{a}}_{j}^{†} , and {\hat{p}}_{j} = - i ( {\hat{a}}_{j} - {\hat{a}}_{j}^{†} ) ,\end{matrix} \qquad [ Equation 1 ]$$

and a mode index j(1≤j≤60) follows the wavelength mode of FIG. 1B.

The measured quantum state was an x-squeezed vacuum state in all antisymmetric modes, and was a p-squeezed vacuum state in all symmetric modes. In order to further explore the correlation between wavelength modes, Vₓₓ and Vₚₚ were constructed from 16,000 measurement results for each x quadrature and p quadrature, which corresponds to the XX block and PP block's covariance matrices. In order to emphasize the correlation compared to a simple variance in shot noise, Vₓₓ-I and Vₚₚ-I are presented in FIG. 2B. Here, I is a 60×60 identity matrix. Diagonal elements of Vₓₓ and Vₚₚ are always greater than 1, and antidiagonal elements strongly indicate a positive correlation in the case of Vₓₓ, and strongly indicate a negative correlation in the case of Vₚₚ, which coincides with the result of FIG. 2A.

In order to clearly analyze the squeezing characteristics of each EPR mode, variances of the x quadrature and the p quadrature were calculated for all symmetric and antisymmetric EPR pairs based on the same raw quadrature data. The result is shown in FIG. 2C, where x_{±} and p_{±} mean x and p quadratures of symmetric and antisymmetric modes, respectively. It was shown that variances of x.♀|p₊ were squeezed in all 30 pairs of EPR states. Because spectra of wavelength modes 30 and 31 overlap, interference occurs at a center wavelength, so that the spectrum of the antisymmetric mode (31,30) becomes narrower, and the symmetric mode becomes wider. Due to this, for the EPR pair (31,30), p²₊shows stronger squeezing than other symmetric modes, and x². shows weaker squeezing than other antisymmetric modes.

In addition, entanglement was verified for each pair using a Duan inseparability criterion. The Duan criterion is as in [Equation 2] below. Based on this, as shown in FIG. 2D, all 30 pairs of EPR pairs clearly passed an entanglement discrimination test.

$$〈 Δ {x}_{-}^{2} 〉 + 〈 Δ {p}_{+}^{2} 〉 < 2 \qquad [ Equation 2 ]$$

### 4. Multipartite Quantum State

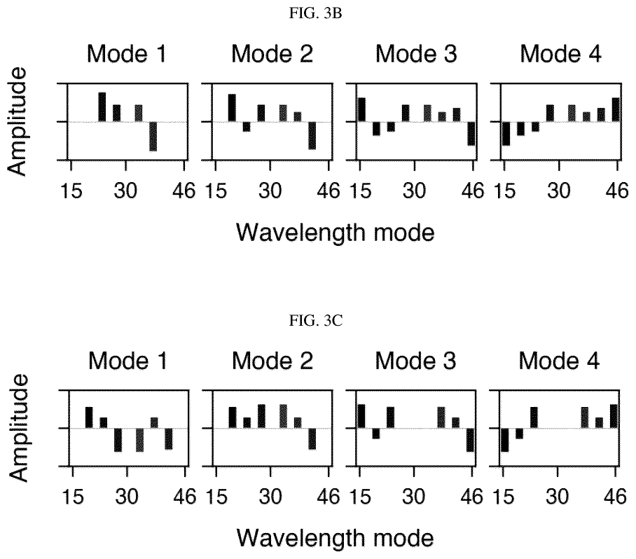

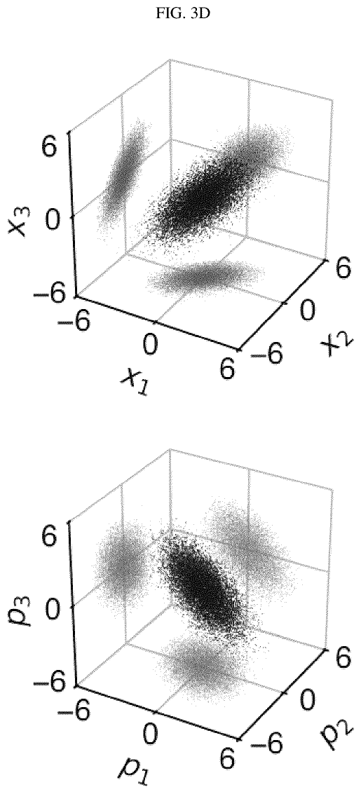

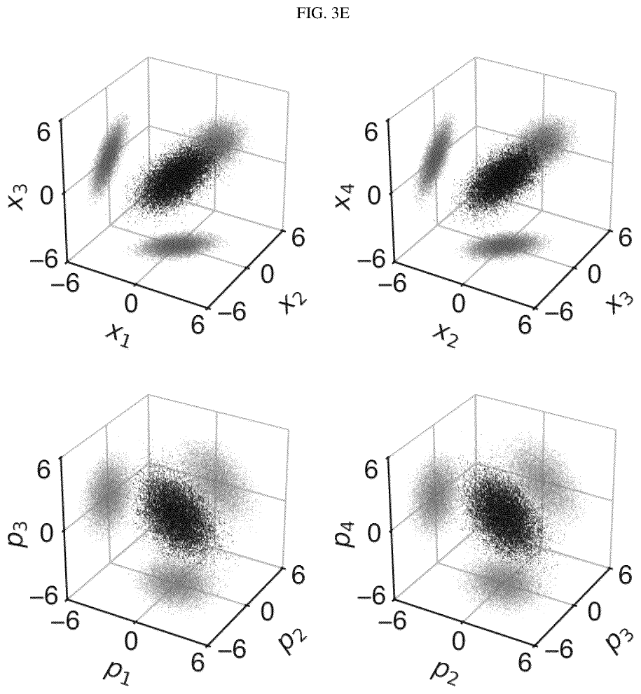

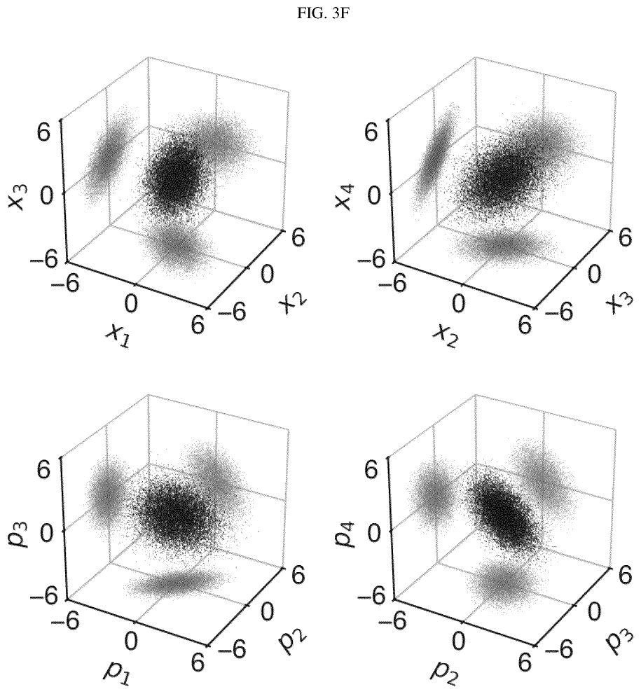

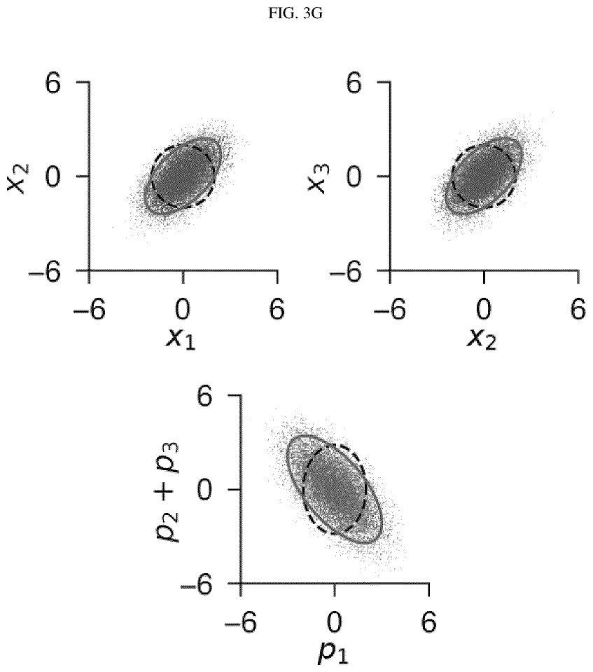

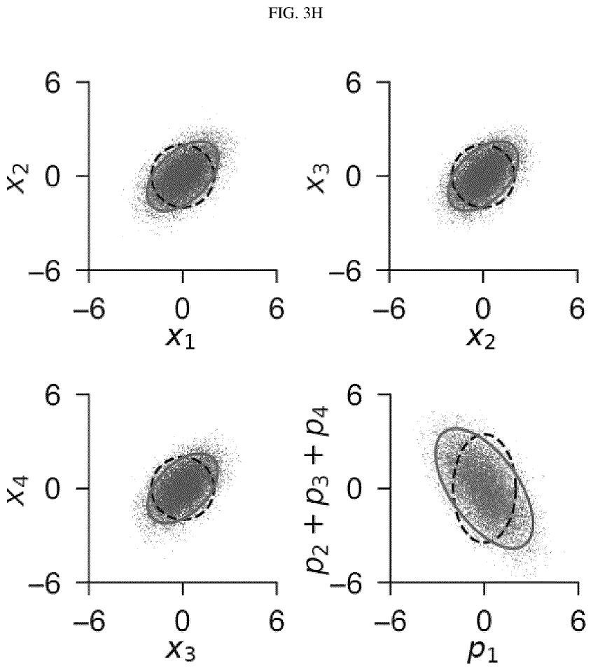

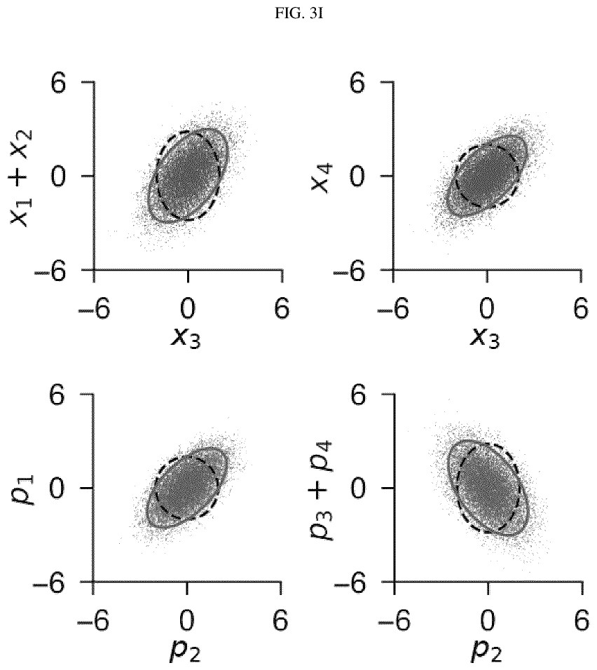

FIGS. 3A to 3I are drawings for explaining a multipartite entangled state according to the present disclosure.

One of the important advantages of simultaneous quadrature measurement is that quadrature measurement on a superposed mode basis is possible without using a beam splitter network (BSN). More specifically, for a BSN expressed as a real unitary matrix, an x (or p) quadrature can be simultaneously measured on a superposition basis. Utilizing this characteristic, multipartite entanglement when the state measured in FIG. 2A is measured on a superposed mode basis was verified. After generating a multipartite entangled state by combining EPR states, a quadrature of each entangled mode was measured using the camera-based homodyne detector. Since quadrature results for all wavelength modes are simultaneously acquired, a linear superposition of them can also be extracted.

In the present disclosure, quadrature results for three entangled states, that is, GHZ₃, GHZ₄, and LS₄, were acquired. GHZ₃ and GHZ₄ are 3-mode and 4-mode Greenberger-Horne-Zeilinger (GHZ) states, respectively, and LS₄ is a state locally equivalent to 4-mode linear and square cluster states through Fourier transform. Each state is defined by a nullifier operator. For convenience, a normalized nullifier having a variance of 1 in a vacuum state and a value less than 1 in an entangled state was used.

A quadrature result was acquired for a mode of each entangled state, and an entanglement discrimination criterion was verified. FIGS. 3A to 3C show normalized amplitudes in a wavelength region corresponding to each state. This amplitude is a real (superposition) linear combination of the 15th to 46th wavelength modes defined in FIG. 1B. To prevent an unwanted quadrature correlation that that may occur when wavelength modes are incorrectly connected, and to improve a squeezing level of each EPR pair, two adjacent modes were grouped into one effective mode, and a gap was introduced between the used EPR modes.

A correlation between quadrature results was analyzed for the modes of the entangled states presented in FIGS. 3A to 3C. FIGS. 3D to 3F show 3D scatter plots for 16,000 quadrature sets for each entangled state. Black dots represent a correlation between three modes of an entangled state, and red (x) and blue (p) dots are two-dimensional projections of this data, showing a quadrature correlation between two modes. In order to investigate a nullifier correlation, a quadrature set constituting a nullifier was visualized in FIGS. 3G to 3I. Purple and black dotted ellipses represent covariance matrices of the measured quantum state and vacuum state, respectively. A boundary of each ellipse corresponds to twice the standard deviation of a corresponding weight, and a correlation between quadrature components can be visually confirmed through the shape and slope of the ellipse. The more the ellipse is elongated and tilted, the stronger the correlation it means.

In all three entangled states, the variance of the nullifier mode was between 0.637 and 0.647, and the standard deviation was measured to be 0.007. This is a value clearly lower than a vacuum noise level, clearly showing that the corresponding quantum state is entangled. Based on this result, entanglement of the quantum state was confirmed by applying van Loock-Furusawa entanglement discrimination criterion (see P. van Loock and A. Furusawa, Detecting genuine multipartite continuous-variable entanglement, Phys. Rev. A 67, 052315 (2003), and W. Asavanant and A. Furusawa, Multipartite continuous-variable optical quantum entanglement: Generation and application, Phys. Rev. A 109, 040101 (2024).). All of the GHZ₃, GHZ₄, and LS4 states satisfied the entanglement discrimination criterion.

### 5. Remote State Preparation (RSP)

Another application example of the present detector is remote state preparation. This is a quantum process of preparing a desired quantum state using an entanglement resource and measurement (see C. H. Bennett, D. P. DiVincenzo, P. W. Shor, J. A. Smolin, B. M. Terhal, and W. K. Wootters, Remote state preparation, Phys. Rev. Lett. 87, 077902 (2001).). In RSP, first, Alice and Bob share an entangled state. Thereafter, Alice performs measurement on a part of her system according to a quantum state to be generated, and transmits a measurement result to Bob. Bob generates a target quantum state by applying a specific quantum operation to his system using Alice's measurement result. For example, in CV quantum optics, a squeezed vacuum state can be generated in an RSP manner using an EPR state and a displacement operator (see Z. Kurucz, P. Adam, Z. Kis, and J. Janszky, Continuous variable remote state preparation, Phys. Rev. A 72, 052315 (2005), and D. Han, N. Wang, M. Wang, Z. Qin, and X. Su, Remote preparation and manipulation of squeezed light, Opt. Lett. 47, 3295 (2022).).

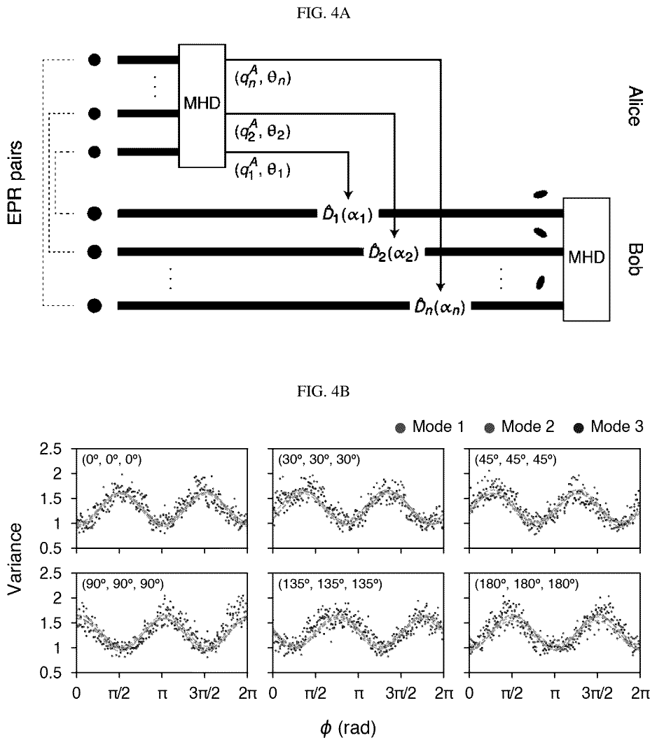

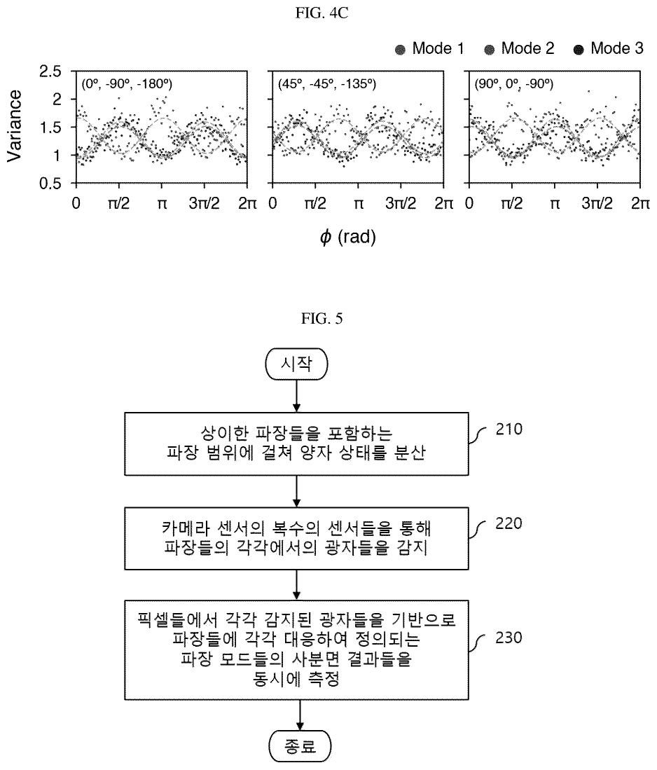

FIGS. 4A to 4C are drawings for explaining multimode RSP according to the present disclosure.

In the present disclosure, a possibility of generating a multimode squeezed vacuum state utilizing an EPR state pair and a camera-based multimode homodyne detector was analyzed. A basic concept of multimode RSP is shown in FIG. 4A. Multimode EPR states are prepared, and Alice and Bob each share one part of each pair. After measuring an x-quadrature in her mode of each pair, Alice transmits an obtained quadrature result xnA to Bob. Bob performs a coherent displacement operation on his mode as in [Equation 3] below. After performing the displacement operation, Bob's output quantum state is converted from a thermal state to a squeezed vacuum state, and at this time, a squeezing angle is determined by Alice.

$${α}_{n} = λ {x}_{n}^{A} = exp [ i ( {θ}_{n}^{A} + {θ}_{n}^{B} ) ] \qquad [ Equation 3 ]$$

Here, Vₛ [symbol] are squeezing and anti-squeezing variances of an EPR mode, respectively,

$$λ = \frac{{V}_{a} - {V}_{s}}{{V}_{a} + {V}_{s}} ,$$

and θₙ^{A} and θₙ^{B} are nth mode phases of Alice and Bob, respectively.

In this experiment, a global phase of an EPR pair was scanned, and xₙ^{A} was measured while changing a relative phase θₙ^{A} with respect to a reference EPR pair 30 times at intervals of 12° from 0° to 348°. θₙ^{B} was fixed to the phase of the reference EPR pair. For each phase setting, a total of 57,600 quadratures were acquired, and quadrature data within a range of θₙ^{A}±3° was selected. Thereafter, Bob's role was performed in a numerical calculation manner, and was processed by adding a displacement value an to Bob's quadrature xₙ^{B}.

FIGS. 4B and 4C show measured quadrature variances for each mode of a 3-mode squeezed state generated in an RSP manner. A squeezing angle of each mode varies depending on Alice's phase, which determines a quadrature variance of an RSP squeezed state. Alice's phase (θ₁^{A},θ₂^{A},θ₃^{A}) is specified at the top of each plot. FIG. 4B is a case of θ₁^{A}=θ₂^{A}=θ₃^{A}, and FIG. 4C is a case of θ₂^{A}=θ₁^{A}=π/2, θ₃^{A}−θ₁^{A}−π. As is known, squeezing in a squeezed vacuum state of an RSP manner only when an original EPR squeezing loss is less than 50% is observed. EPR squeezing and anti-squeezing variances measured in this experiment were about 0.60-0.62 and 2.63-2.70 for each mode, respectively. Therefore, a total loss of an EPR pair is estimated to be approximately 50%, and a variance of an RSP state was at a level similar to a vacuum fluctuation level. The loss of the measured state is composed as follows: 30% loss from state preparation, 10% homodyne contrast loss, and 10% camera detection system loss. Among these, a grating accounts for 6%, a camera protection window accounts for 1%, and a camera sensor accounts for 3% of the loss.

### 6. Conclusion

In the present disclosure, a simultaneous wavelength multimode homodyne detector utilizing a camera was implemented. Light of different wavelengths is dispersed to different camera pixels, and a quadrature value for each mode is simultaneously acquired. It was demonstrated that the present detector operates effectively as a multimode homodyne detector. Specifically, crosstalk between modes did not affect a quadrature result, and electronic noise was sufficiently low, so that a clearance of 20 dB or more could be obtained with only a few nW level of LO power in all modes. In addition, it was confirmed that the measured vacuum state follows a Gaussian distribution without a mean field.

Quadrature values for 30 pairs of EPR states derived from 60 wavelength modes were simultaneously measured. Squeezing was confirmed in all modes, and an entanglement discrimination criterion was satisfied. This measurement method was applied to various quantum information processing tasks. An example thereof is verification of an entanglement discrimination criterion for a multimode entangled state. Using the present detection system, quadrature values of 3-mode and 4-mode GHZ states and an LS4 state (a state locally equivalent to 4-mode CV linear and square cluster states) were acquired. All of these states satisfied a van Loock-Furusawa criterion. Finally, through remote state preparation (RSP) of an EPR state, a 3-mode squeezed state was generated. It was observed that a relative phase of two RSP participants determines a variance of a quadrature result.

The present multimode homodyne detector will open a path for the advancement of multimode quantum information processing. Since all quadrature results are simultaneously acquired, characteristic analysis of a multimode state and process is dramatically streamlined. For example, when attempting to fully characterize an M-mode quantum state, a total of M (2M+1) measurement settings are required in a method using an existing homodyne detector and an LO shaper. However, if the present camera-based multimode homodyne detector is used, the number of required measurement settings is reduced to only log 2 M+3 when an LO phase of each mode is appropriately selected. This drastically reduces the number of measurement settings.

In a practical aspect, the camera-based multimode homodyne detector provides a powerful platform for multimode quantum sensing. A squeezed vacuum state is widely utilized in quantum metrology, but slow development of multimode homodyne detection has limited its application. The present detector enables implementation of various quantum metrology schemes requiring simultaneous multimode measurement (e.g., multimode phase estimation, function estimation, quantum illumination, array homodyning, and even quantum imaging).

Now, based on the above-described contents, a quantum homodyne detection method will be described. FIG. 5 is a drawing illustrating an operating method of the quantum homodyne detection device according to the present disclosure.

Referring to FIG. 5, first, in step 210, the quantum homodyne detection device may disperse a quantum state over a wavelength range including different wavelengths. In some embodiments, an oscillator may output a uniform spectrum over a wavelength range, and a laser may generate a quantum state with quantum light having a center wavelength of the wavelength range. Then, a beam splitter may interfere the quantum state from the laser and the spectrum from the oscillator to output two output beams. Then, diffraction gratings and optical systems may respectively disperse the output beams over wavelengths.

Next, in step 220, the quantum homodyne detection device may sense photons at each of the wavelengths through a plurality of sensors of a camera sensor. Specifically, the camera sensor has a plurality of pixels respectively corresponding to different wavelengths, and may sense photons at each of the wavelengths through the pixels. For example, the pixels may be arranged in one dimension or may be arranged in two dimensions. In some embodiments, two identically configured camera sensors may exist. The camera sensors respectively receive the output beams, and each camera sensor may sense photons at each of the wavelengths through the pixels.

Next, in step 230, the quantum homodyne detection device may simultaneously measure quadrature results of wavelength modes defined corresponding to the respective wavelengths based on the photons respectively sensed at the pixels of the camera sensor. In some embodiments, a digital processor may remove classical noise by weighted-summing photons sensed in time series through the camera sensor, and then measure quadrature results of the wavelength modes. In some embodiments, the digital processor may divide one camera sensor into two regions, and subtract quadrature results from the regions to detect final quadrature results. In other embodiments, the digital processor may subtract quadrature results from two camera sensors to detect final quadrature results. For example, the wavelength modes may be 60, but are not limited thereto.

Additionally, the digital processor may simultaneously measure quadrature values of a quantum state existing in the wavelength modes. In some embodiments, the digital processor may simultaneously measure quadrature values of EPR modes generated as pairs of wavelength modes, but is not limited thereto. For example, the EPR modes may be 30 pairs of wavelength modes, but are not limited thereto. Additionally, the digital processor may generate multipartite entangled states by combining wavelength modes, and measure quadrature values of the multipartite entangled states. For example, each of the multipartite entangled states may be formed of a combination of 3 wavelength modes or 4 wavelength modes, but is not limited thereto.

According to the present disclosure, a quadrature value of a wavelength multimode quantum state can be simultaneously acquired using a camera. A core idea is that the camera operates as a spectrally resolving detector, and each pixel senses light of a different wavelength. By expanding the number of simultaneous quadrature measurement modes, which was a maximum of 8 modes in existing studies, to 60, this method recorded the largest number of modes at the present time. As crosstalk between modes is small, electronic noise is low, and a Gaussian distribution of a vacuum state quadrature exists, the present camera detection system operates as an effective multimode homodyne detector. In particular, all these performances were implemented with only nW-class LO power.

This can be utilized for the development of scalable quantum technology by drastically increasing the scale of a quantum measurement device corresponding to a measurement unit of quantum technology. And, it provides a technology for simultaneously measuring a large-scale quantum state in the quantum computing field. In addition, it can be utilized for quantum imaging and quantum spectroscopy technologies using quantum light in the quantum sensing field. Furthermore, it can be utilized for quantum key distribution and quantum teleportation technologies in the quantum communication field.

The device described above may be implemented as a hardware component, a software component, and/or a combination of a hardware component and a software component. For example, the device and components described in the embodiments may be implemented using one or more general-purpose computers or special-purpose computers, such as a processor, a controller, an ALU (arithmetic logic unit), a digital signal processor, a microcomputer, an FPGA (field programmable gate array), a PLU (programmable logic unit), a microprocessor, or any other device capable of executing and responding to an instruction. The processing device may execute an operating system (OS) and one or more software applications executed on the operating system. In addition, the processing device may access, store, manipulate, process, and generate data in response to the execution of software. For convenience of understanding, the processing device is sometimes described as being used as a single unit, but those skilled in the art will recognize that the processing device may include a plurality of processing elements and/or a plurality of types of processing elements. For example, the processing device may include a plurality of processors or one processor and one controller. In addition, other processing configurations, such as a parallel processor, are also possible.

Software may include a computer program, code, an instruction, or a combination of one or more thereof, and may configure a processing device to operate as desired or command the processing device independently or collectively. Software and/or data may be interpreted by a processing device or to a processing device to provide an instruction or data, embodied in any type of machine, component, physical device, computer storage medium, or device. Software may be distributed over networked computer systems so that it is stored or executed in a distributed manner. Software and data may be stored in one or more computer-readable recording media.

A method according to various embodiments may be implemented in the form of program instructions that can be executed through various computer means and recorded in a computer-readable medium. At this time, the medium may continuously store a computer-executable program, or temporarily store it for execution or download. In addition, the medium may be various recording means or storage means in the form of a single hardware or a combination of several hardware, and is not limited to a medium directly connected to a certain computer system, but may exist distributed over a network. Examples of the medium may include magnetic media such as a hard disk, a floppy disk, and a magnetic tape, optical recording media such as a CD-ROM and a DVD, magneto-optical media such as a floptical disk, and those configured to store program instructions, including a ROM, a RAM, a flash memory, and the like. In addition, examples of other media may include recording media or storage media managed by an app store that distributes applications or sites, servers, and the like that supply or distribute various other software.

Various embodiments of the present document and terms used therein are not intended to limit the technology described in the present document to specific embodiments, and should be understood to include various modifications, equivalents, and/or alternatives of the corresponding embodiments. In connection with the description of the drawings, similar reference numerals may be used for similar components. A singular expression may include a plural expression unless the context clearly dictates otherwise. In the present document, expressions such as “A or B”, “at least one of A and/or B”, “A, B or C”, or “at least one of A, B and/or C” may include all possible combinations of the items listed together. Expressions such as “first”, “second”, “firstly”, or “secondly” may modify corresponding components regardless of order or importance, and are used only to distinguish one component from another component and do not limit the corresponding components. When it is mentioned that a certain (e.g., first) component is “(functionally or communicatively) connected” or “coupled” to another (e.g., second) component, the certain component may be directly connected to the other component, or may be connected through another component (e.g., third component).

According to various embodiments, each component (e.g., a module or a program) of the described components may include a singular or a plurality of entities. According to various embodiments, one or more components or steps among the above-described corresponding components may be omitted, or one or more other components or steps may be added. Alternatively or additionally, a plurality of components (e.g., modules or programs) may be integrated into one component. In this case, the integrated component may perform one or more functions of each component of the plurality of components identically or similarly to those performed by the corresponding component among the plurality of components prior to integration. According to various embodiments, steps performed by a module, a program, or another component may be executed sequentially, in parallel, repeatedly, or heuristically, or one or more of the steps may be executed in a different order, omitted, or one or more other steps may be added.

What is claimed is:

1. A quantum homodyne detection device, wherein the quantum homodyne detection device comprises:
a camera sensor having a plurality of pixels respectively corresponding to different wavelengths, and configured to detect photons in each of the wavelengths from a quantum state dispersed across the wavelengths through the pixels; and
a digital processor configured to simultaneously measure quadrature results of wavelength modes defined respectively corresponding to the wavelengths, based on the photons respectively detected in the pixels.

2. The quantum homodyne detection device according to claim 1, wherein the digital processor is configured to remove classical noise by weighted-summing the photons detected in a time series through the camera sensor, and then measure the quadrature results of the wavelength modes.

3. The quantum homodyne detection device according to claim 1, wherein the quantum homodyne detection device further comprises:
an oscillator having a uniform spectrum across a wavelength range including the wavelengths;
a laser configured to generate a quantum state with quantum light having a center wavelength of the wavelength range;
a beam splitter configured to interfere the quantum state from the laser and the spectrum from the oscillator, to output two output beams for the camera sensor and another camera sensor; and
diffraction gratings and optical systems configured to respectively disperse the output beams across the wavelengths for the camera sensor and the other camera sensor.

4. The quantum homodyne detection device according to claim 1, wherein the digital processor is configured to simultaneously measure quadrature values of a quantum state existing in the wavelength modes.

5. The quantum homodyne detection device according to claim 4, wherein the digital processor is configured to combine the wavelength modes to generate multipartite entanglement states, and measure the quadrature values of the multipartite entanglement states.

6. The quantum homodyne detection device according to claim 5, wherein the digital processor is configured to extract a linear superposition of the simultaneously measured quadrature results without passing through a beam splitter network (BSN) to verify the multipartite entanglement states.

7. The quantum homodyne detection device according to claim 1, wherein the digital processor is configured to perform balanced homodyne detection by subtracting signals obtained from two different homodyne output ports.

8. The quantum homodyne detection device according to claim 1, wherein the measured quadrature results are provided to generate a multimode squeezed vacuum state for a remote state preparation (RSP) protocol, and a quadrature result measured in a first mode among the wavelength modes is used for a coherent displacement applied to a second mode to determine a squeezing angle of the generated squeezed vacuum state.

9. A quantum homodyne detection device, wherein the quantum homodyne detection device comprises:
an oscillator having a uniform spectrum across a wavelength range including different wavelengths;
a laser configured to generate a quantum state with quantum light having a center wavelength of the wavelength range;
a beam splitter configured to interfere the quantum state and the spectrum, to output two output beams;
diffraction gratings and optical systems configured to respectively disperse the output beams across the wavelengths;
a camera sensor having a plurality of pixels respectively corresponding to the wavelengths, and configured to receive the output beams and detect photons in each of the wavelengths through the pixels; and
a digital processor configured to simultaneously measure quadrature results of wavelength modes defined respectively corresponding to the wavelengths, based on the photons detected in the pixels.

10. A quantum homodyne detection method, wherein the quantum homodyne detection method comprises:
a step in which a camera sensor having a plurality of pixels respectively corresponding to different wavelengths detects photons in each of the wavelengths from a quantum state dispersed across the wavelengths through the pixels; and
a step in which a digital processor simultaneously measures quadrature results of wavelength modes defined respectively corresponding to the wavelengths, based on the photons respectively detected in the pixels.
